(19) United States
(12) Patent Application Publication
(10) Pub. No.: US 2016/0292015 A1
(43) Pub. Date: Oct. 6, 2016

(54) PROCESSOR FREQUENCY SCALING BASED UPON LOAD TRACKING OF DEPENDENT TASKS

(71) Applicant: Qualcomm Innovation Center, Inc., San Diego, CA (US)

(72) Inventors: Premal Shah, San Diego, CA (US); Rajulu Ponnada, Hyderabad (IN); Stephen Muckle, San Diego, CA (US)

(21) Appl. No.: 15/081,823

(22) Filed: Mar. 25, 2016

Related U.S. Application Data
(60) Provisional application No. 62/142,604, filed on Apr. 3, 2015.

(51) Int. Cl. G06F 9/52; G06F 9/50; G06F 9/44

(52) U.S. Cl. CPC G06F 9/52; G06F 9/4443; G06F 9/505

(57) ABSTRACT

A computing device comprising a user interface screen with a user interface associated with a plurality of user interface tasks. The computing device comprises a plurality of processing units operating at a processing unit frequency. The computing device further comprises an operating system comprising a dependent task identifier and a CPU frequency scaling governor. The dependent task identifier identifies one or more user interface tasks which are dependent on at least one other user interface task and provides to the CPU frequency scaling governor an aggregate frequency for the one or more user interface tasks. The CPU frequency scaling governor sets the plurality of processing units to the aggregate frequency.

### PRIORITY

This application claims priority to U.S. Provisional Application No. 62/142,604, filed Apr. 3, 2015 and entitled “Processor Frequency Scaling Based Upon Load Tracking of Dependent Tasks”, which is incorporated herein by reference in its entirety.

### FIELD OF THE INVENTION

The present disclosed embodiments relate generally to computing devices, and more specifically to frequency control of multi-core processors of computing devices.

### BACKGROUND OF THE INVENTION

Computing devices, including mobile computing devices such as, but not limited to, smartphones, tablet computers, gaming devices, and laptop computers are now generally ubiquitous. These computing devices are capable of running a variety of applications on the device (also referred to herein as “apps”), with many of these devices including multiple processors to process tasks that are associated with the apps. In many instances, the multiple processors may be integrated as a collection of processor cores within a single functional processing system. The amount of work that is performed on each processor may be monitored and controlled by a computing device operating system to meet the necessary workload to timely process the tasks.

A user's experience on a computing device is generally dictated by how smoothly the user interface (“UI”) animation runs on the device for any particular application. Sporadic processor workload occurs in order to accurately render user interface (UI) animations (e.g., browser scroll, email scroll, home launcher scrolls, application launches). The Linux® kernel, for example, may use a scheduler and a governor to adjust the processing frequency on the processors to meet this sporadic workload. These features monitor the workload and adjust a corresponding processor clock frequency based on the workload. However, due to the sporadic nature of UI workloads, processor frequency adjustment mechanisms currently employed by the Linux kernel, and others, often fail to process UI tasks in a manner which provides a smooth (aka “jank-free”) viewing experience.

On some devices which employ the Android operating system, UI processing tasks may be split up and processed by at least three processing threads. These three threads may comprise the UI/Activity main thread, UI Renderer thread, and Binder transaction thread. Task dependency is established by the UI Activity thread waking-up the UI Renderer thread which further wakes-up the binder thread in the dependency chain. Splitting up the UI workload into such dependent threads allows for parallel processing of UI tasks on a multicore CPU when processing the workload of one UI frame to the next. In an ideal scenario, these three dependent threads should complete the entire UI workload processing in under 16.66 ms (for a 60 Hz display panel) to ensure 60 fps (60 Hz display panel) and a smooth user experience on the display panel. However, these dependent tasks can be scheduled to run on different CPU cores by the operating system scheduler, and as a result the CPU frequency scaling governor may fail to see the combined UI workload. This often results in a lower than required CPU frequency being selected by the governor. Therefore, existing approaches to handling sporadic UI workloads may cause stuttering/jank and/or poor application performance.

### SUMMARY OF THE INVENTION

In order to eliminate the problems associated with the prior version of the Linux kernel in adjusting the processor frequency to handle UI tasks, Applicant has developed a computing device comprising a UI screen with a user interface associated with a plurality of UI tasks. The computing device further comprises a plurality of processing units operating at a processing unit frequency and an operating system comprising a dependent user interface (UI) task identifier and a CPU frequency scaling governor. The dependent task identifier identifies one or more UI tasks which are dependent on at least one other UI task and provides to the CPU frequency scaling governor an aggregate frequency for the one or more UI tasks. The CPU frequency scaling governor sets the plurality of processing units to the aggregate frequency.

Applicant has further developed a method of adjusting a processing unit frequency. One such method comprises initiating a user interface workload on a plurality of processing units with the user interface workload comprising a plurality of UI tasks. The method further comprises identifying one or more of the plurality of UI tasks that are dependent on at least one other of the plurality of UI tasks and also determining an aggregate load on the plurality of processing units for the one or more of the plurality of UI tasks that are dependent on at least one other of the plurality of UI tasks. Finally, the method comprises setting a frequency of the plurality of processing units to the aggregate load.

Furthermore, Applicant has developed a non-transitory, tangible computer readable storage medium, encoded with processor readable instructions to perform a method of adjusting a processing unit frequency. One such method comprises initiating a user interface workload on a plurality of processing units. The application animation workload comprises a plurality of UI tasks. The method further comprises identifying one or more of the plurality of UI tasks that are dependent on at least one other of the plurality of UI tasks and determining an aggregate load on the plurality of processing units for the one or more of the plurality of UI tasks that are dependent on at least one other of the plurality of UI tasks. Finally, the method comprises setting a frequency of the plurality of processing units to the aggregate load.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 depicts a logical block diagram of a computing device according to one or more embodiments of the invention;

FIG. 2 depicts a method according to one embodiment of the invention;

FIG. 3 depicts a logical block diagram of a computer that may implement aspects of the present disclosure; and

FIG. 4 depicts a processing unit workload according to one embodiment of the invention.

FIG. 5 depicts a method according to one embodiment of the invention.

### DETAILED DESCRIPTION

The word “exemplary” is used herein to mean “serving as an example, instance, or illustration.” Any use of the term “exemplary” herein is not necessarily to be construed as preferred or advantageous over other embodiments.

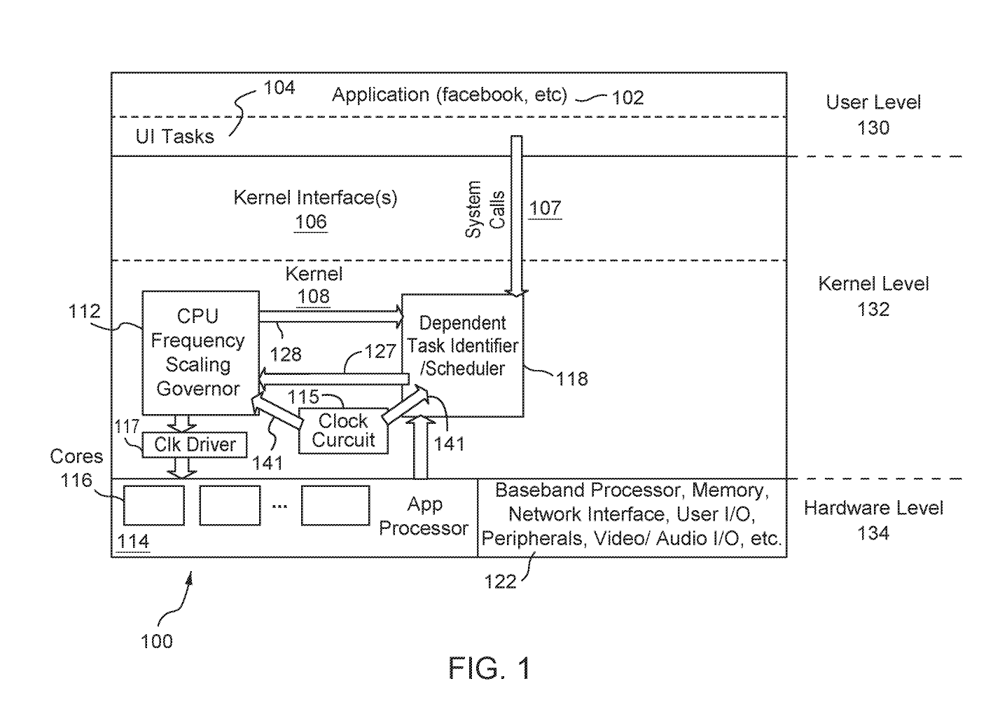

Turning first to FIG. 1, seen is a block diagram illustrating components of a computing device 100 (also referred to herein as a computing system 100 or a mobile computing device 100). The block diagram includes application 102 (e.g., Gmail, Facebook, etc.) and a UI tasks 104 within the application process which are responsible for performing UI animation in response to any user interface interaction (e.g. scrolling through the Facebook newsfeed on top of a touchscreen enabled mobile display device). The applications and UI tasks are located at a highest level of abstraction, the user level 130 (also referred to herein as a user-space 130). At the lowest level of abstraction, the hardware level 134 (also referred to herein as a hardware space 134), the embodiment may comprise hardware such as, but not limited to, an applications processor 114 (also referred to herein as an app processor 114, processor 114, or processors 114), which may comprise a plurality of processing cores 116. The processor 114 and/or processing cores 116 may also be referred to herein as a processing unit 116, where appropriate. Although the specific embodiment depicted in FIG. 1 depicts multiple processor cores 116 within an app processor 114, it should be recognized that other embodiments include a plurality of processor cores 116 that are not integrated within a single app processor 114, but may be within discrete processors 114. As a consequence, the operation of multiple processors is described herein in the context of both multiple processor cores 116, and more generally, multiple processors 114, which may include processor cores and discrete processors.

An operating system comprising an operating system kernel 108 along with one or more interface systems 106 (also referred to herein as a kernel interface 106 and interface 106 or interfaces 106) are located in the kernel level 132 (also referred to herein as a kernel-space 132) and enable communication between the UI tasks 104 and the dependent task identifier 118. In particular, the interface 106 passes and/or modifies system calls 107 between the UI tasks 104 and the kernel 108. A CPU frequency scaling governor 112 (also referred to herein as a governor 112, processor governor 112, and/or CPU-freq governor 112) may comprise a software module/driver inside the kernel 108 that operates to set a frequency of the online processing cores 116 within the app processor 114. Similarly, the dependent task identifier 118 (also referred to herein as a scheduler 118, process scheduler 118, task scheduler 118, or scheduling component 118) may also comprise a software module/driver inside the kernel 108 that identifies UI animation rendering tasks dependent on one or more other UI animation rendering tasks.

In processing the one or more UI tasks 104, the processing units 116 operate at a processing unit frequency. This processing unit frequency may also be referred to as a processor load. In one embodiment, the processing units 116 operate at a frequency insufficient to complete the tasks necessary to provide a new animation frame update within the frame rate associated with the display panel. For display panels comprising a 60 Hz (fps) refresh rate that use vertical synchronization (VSYNC), all the UI tasks 104 processing is required to be completed within 16.66 milliseconds (aka VSYNC period) for a stutter-free (no repeated frames) user experience on the display. In order to set the processing units 116 at the frequency required to complete the UI workload within this VSYNC time period, a portion of the operating system, for example a Dependent task identifier 118 in the kernel 108, may identify which UI tasks 104 are dependent upon the completion of one or more other tasks (through the interface 106 and system calls 107).

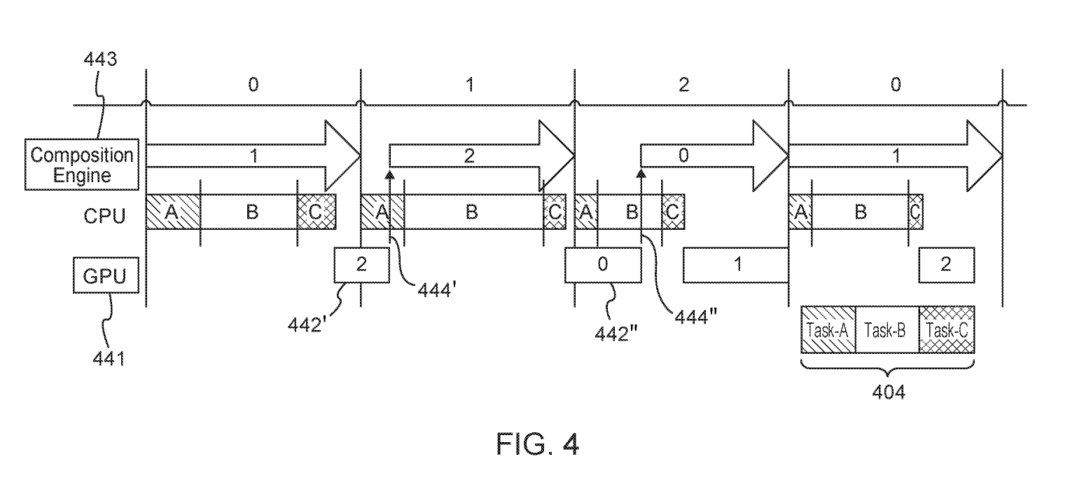

Seen in FIG. 4 is one example of a UI animation workload (e.g. Gmail® scroll, Facebook® scroll and/or Twitter® scroll) comprising three distinct but dependent UI tasks 404. Gmail® is a trademark of Google, Inc., a Delaware Corporation with a principal place of business at 1600 Amphitheater Parkway, Building 41, Mountain View, Calif. 94043, Facebook® is a trademark of Facebook, Inc., a Delaware Corporation having a principal place of business at 1601 Willow Road, Menlo Park, Calif. 94025, and Twitter® is a trademark of Twitter, Inc., a Delaware Corporation having a principal place of business at 1355 Market Street, Suite 900, San Francisco Calif., 94103. As seen in FIG. 4, these UI tasks 404 may be referred to as task A, task B, and task C and each such task can be scheduled to run on any of the available online processing cores 116. The CPU scaling governor (e.g. interactive or on demand governors) as used in current modern operating system (e.g. Android) would scale the CPU frequency based on the maximum load sampled across all the individual online cores 116. For example, if there are four synchronous cores (Core0, Core1, Core2, Core3) in the App processor 114, the CPU frequency scaling governor would independently sample the load on all four cores (Core0, Core1, Core2, Core3) within a sampling window (i.e., 20 ms on an operating system like Android). The CPU core which has the largest load for a given sampling window would determine the final cluster frequency for the App processor 114 for the next sampling window and set all four cores at this largest load frequency. As is also the case in a current operating system, when a set of dependent tasks are scheduled to run across different cores (by the operating system scheduler) within a governor sampling window, the governor is unable to sample the combined load for these dependent tasks, and only able to sample each individual load. In the FIG. 4 example, task A is processed before processing begins on task B and processing on task B is complete before processing is initiated on task C for each frame (0, 1, 2, etc.). In such a scenario, the second and third tasks are dependent tasks. The combined UI workload of task A, task B and task C is required to complete under 16.66 ms (for a 60 Hz panel) to get 60 fps and a smooth user experience. If the CPU governor cannot see the aggregate load of task A+task B+task C, it will likely choose a lower CPU frequency for the App processor 114 and as a result the UI workload will likely not complete in less than 16.66 ms, thereby causing visible stutter on the display.

Therefore, the Dependent task identifier 118 identifies the one or more UI tasks which are dependent on at least one other UI task. Here, the Dependent task identifier 118 would identify tasks A, B, and C. Such tasks may be referred to as a dependent task string. Upon determining the dependent task string, the Dependent task identifier 118 may then determine the processing frequency required to perform each of these tasks within the desired time, also referred to herein as a predetermined time, and then determine the aggregate processing frequency across all of the tasks in the dependent task string. The Dependent task identifier 118 may then provide the aggregate frequency for the one or more UI tasks to the CPU frequency scaling governor 112. Upon receiving the aggregate frequency needed to complete the processing of the one or more UI tasks, the CPU frequency scaling governor 112 may set the plurality of processing units 116 to the aggregate frequency via the clock driver 117. For example, the CPU workload may comprise an implicit deadline of 16.66 ms to keep a healthy 60 fps UI performance. In such a scenario, the Dependent task identifier 118 may determine, and the CPU frequency scaling governor 112 may set, the processing units to a clock rate frequency within a range of 2.0 to 2.5 GHz. In the FIG. 4 example, the GPU 441 may complete the buffer 442′, 442″ prior to the composition engine 443 initializing 444′ and 444″.

In one embodiment, the App processor 114 may comprise a quad core system comprising Core0, Core1, Core2, and Core3. For simplicity, App processor 114 may comprise a synchronous Quad core system where all the processing cores 116 run at the same frequency (as used by most modern mobile smartphones). In such a system, the frequency of the app processor 114 may be determined through the CPU frequency scaling governor 112 by sampling the max load across all the individual processing cores 116 as follows:

Load for app processor 114=Max {(load at Core0),(load at Core1),(load at Core2),(load at Core3)}

The CPU Frequency scaling governor 112 uses this sampled load value for the app processor 114 to scale (up or down) and set the corresponding CPU frequency for the app processor 114, using the CPU clock driver 117. In one embodiment, the Dependent task identifier 118 may be part of the operating system scheduler. As seen in FIG. 4, the three UI dependent tasks (task A, task B, and task C) may be scheduled on three different processing cores 116 along with other non-dependent tasks in the system. Core0 may be running task A of the dependent task string+a few other non-dependent tasks (e.g., task1 and task2); Core1 may be running task B of the dependent task string+another non-dependent task (say task3); Core2 may be running task C of the dependent task string; Core3 may be offline (idle) on the App processor 114. Traditionally the load for app processor 114 would be calculated as:

Load for app processor 114=Max {(load at Core0: taskA+task1+task2),(load at Core1: taskB+task3),(load at Core2: taskC),(load at Core3:0(idle))} Equation-I

Where: taskA, taskB, and taskC are from the dependent task string; and task1, task2, and task3, are other non-dependent system tasks running on the app processor 114. The frequency chosen by the CPU Frequency scaling governor 112 with respect to the above-calculated max load may not be sufficient to ensure all the dependent tasks get to complete under a given timeline. For example: the frequency chosen by CPU Frequency scaling governor 112 for the load on Core0 is only sufficient to run just the tasks running on Core0: taskA+task1+task2; the frequency chosen by CPU Frequency governor 112 for the load on Core1 is only sufficient to run just the tasks running on Core1: taskB+task3; the frequency chosen by CPU Frequency scaling governor 112 for the load on Core2 is only sufficient to run just the tasks running on Core2: taskC Likewise, the max of all the loads across Core0, Core1 and Core2 used to scale and set the final frequency of the app processor 114 (as per Equation-I) may not be sufficient to ensure all the dependent UI tasks (taskA, taskB, taskC) get to complete under a given timeline (i.e. VSYNC period of 16.66 ms for 60 Hz display panel).

In order to service the combined UI load of dependent task string (taskA, taskB and taskC) in a given timeline (i.e. VSYNC period of 16.66 ms for 60 Hz display panel), the load of a dependent task (taskA, taskB, taskC) should be counted as a unified load of all the dependent tasks (i.e. taskA+taskB+taskC), across all online CPU cores 116 which are running at least one of the dependent tasks in the dependent task string. For the above example, the new aggregate load for app processor 114 will be calculated as:

Aggregate load for app processor 114=Max {(aggregate load on Core0: taskA+task1+task2+taskB+taskC),(aggregate load at Core1: taskB+task3+taskA+taskC),(aggregate load at Core2: taskC+taskA+taskB),(aggregate load at Core3:0(idle))} Equation-II

In Equation-I, the Core0 load only accounts for task-A+task1+task2; while with the updated Equation-II the same Core0 is now accounting for the load for the tasks that are actually running on Core0: task-A+task1+task2+load of the remaining dependent tasks running elsewhere: task-B+task-C. Similar load accounting for dependent tasks may be applied to Core1 and Core2: applying load aggregation of dependent tasks. Equation-II above shows one such example of load aggregation; however, depending on how the tasks in the dependent task string are scheduled across processing cores 116, multiple permutations of the above Equation-II are possible to ensure proper load aggregation of the dependent tasks.

The new aggregate frequency chosen by the CPU Frequency scaling governor 112 with respect to the above calculated aggregate load is now sufficient to ensure all the dependent tasks get to complete under a given timeline, regardless of how they are placed to run on the processing Cores 116 by the operating system scheduler 118. For a UI animation, this ensures that animation refreshes on the display without a visible stutter (i.e. jank-free at 60 fps on a 60 Hz display panel). The reason the operating system scheduler 118 may place the dependent tasks onto different processing cores 116 along with other non-dependent task is for load balancing on the app processor 114 and to reduce the overall service time for incoming tasks in to the system.

In one embodiment the Dependent task identifier 118 keeps track of the aggregate load across all online processing cores 116 at a fixed sampling period (typically 20 ms on modern operating systems like ANDROID). Furthermore, the CPU Frequency scaling governor 112 running on any one of the processing cores 116 then queries for the aggregate load across all the online processing cores 116 from the Dependent task identifier 118 at a fixed sampling period (typically 20 ms on modern operating systems like ANDROID). The CPU Frequency scaling governor 112 then uses the max aggregate load seen across all online processing cores 116 as per Equation-II, to scale (up or down) and set the final aggregate frequency of the app processor 114 via the CPU clock driver 117.

In one embodiment, although the CPU Frequency scaling governor 112 may be sampling at a higher rate of 20 ms, the aggregate frequency may be chosen so that the aggregate combined load (including UI dependent task string) will be completed within the VSYNC period (i.e. 16.66 ms for 60 Hz display panel refresh rate) to ensure smooth 60 fps UI animations. For synchronous processing cores 116 design (as used by most modern mobile smartphones), this involves setting the same aggregate frequency across all the online processing cores 116.

In one embodiment the CPU frequency for online processing cores 116 may scale from CPU-min frequency (say 300 MHz) to CPU-max frequency (say 2.5 GHz) via the CPU Frequency scaling governor 112. An alternative approach to manage the workload of dependent task string across multiple processing cores 166 may comprise brute force and sets a much higher CPU-min frequency floor (i.e. say 1.5 GHz) across all the online processing cores 116 during the course of the UI animation (due to lack of accurate load accounting for dependent task string). As a result, the CPU frequency will now scale from 1.5 GHz to 2.5 GHz instead of regular/default 300 Mhz to 2.5 GHz during the UI animation. However, such a naïve brute force method can lead to undesirable higher power on a mobile smartphone platform for UI animations and it still does not guarantee for a 60 fps smooth UI animation across all types of UI workloads/applications 102. Likewise, the new proposed method of load aggregation for dependent task string helps to improve UI animation performance while, at the same time, save on power (by not brute forcing any CPU-min frequency floor) because it latches on to the right aggregate frequency for the app processor 114 for any given UI workload/applications 102.

The Dependent task identifier 118 and the CPU Frequency scaling governor 112 may communicate with a clock circuit 115 to operate periodically over a fixed sampling window. In one embodiment, the sampling window size for the Dependent task identifier 118 and the CPU Frequency governor 112 may be about 20 ms. However the sampling window size for the Dependent task identifier 118 and the CPU Frequency governor 112 may be different and less than 20 ms.

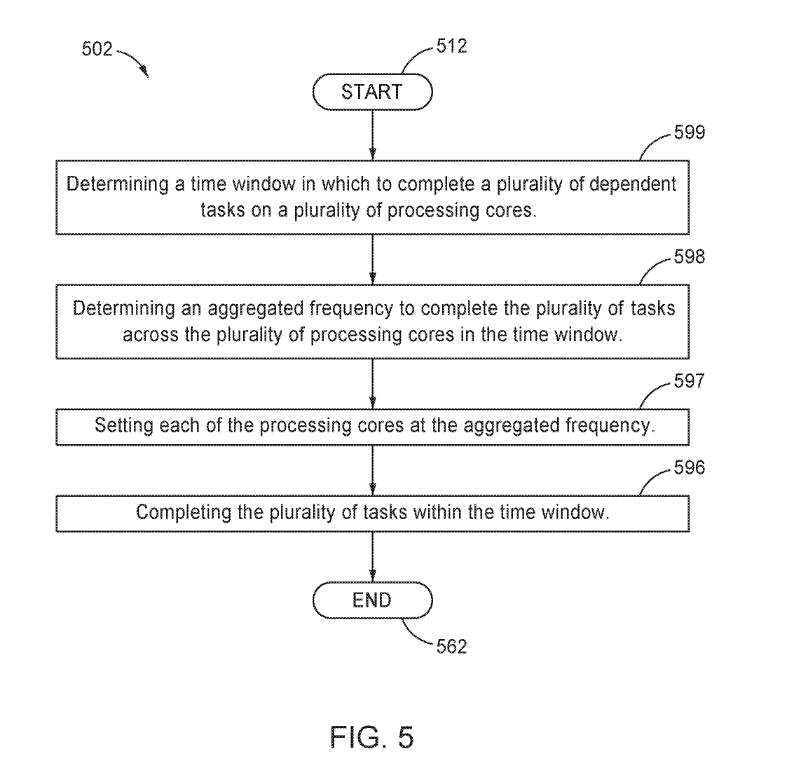

The process described above is seen in the method 502 displayed in FIG. 5. The method 502 starts at 512 and at 599 comprises determining a time window to complete a plurality of tasks on a plurality of processing cores. For example, the time window may comprise the 16.66 ms window, the tasks may comprise dependent tasks A, B, and C, and the cores may comprise Core0, Core1, and Core2, all described above, respectively. At 598 the method 502 may comprise determining an aggregated frequency to complete the plurality of dependent tasks across the plurality of processing cores in the time window. Such an aggregate frequency may comprise the aggregated frequency described above in Equation-II. At step 597 the method 502 comprises setting each of the processing cores at the aggregated frequency. The method 502 then comprises completing the plurality of dependent tasks within the time window at 596, and ends at 562.

As shown with respect to FIG. 4, it is contemplated that one or more UI tasks (tasks B and/or C) are dependent upon the completion of at least one other UI task (A and/or B) in order to complete the processing of the one or more UI tasks (B and/or C). For example, completion of the first task (task A and/or B) may signal the initiation of processing of at least one additional task (task B and/or C). The processing of the at least one additional task may incorporate information received from the processing of the first task.

As one of ordinary skill in the art will appreciate, the user-space 130 and kernel-space 132 components depicted in FIG. 1 may be realized by hardware in connection with processor-executable code stored in a non-transitory tangible processor readable medium such as nonvolatile memory, and can be executed by app processor 114. Furthermore, the hardware space 134 may also comprise or otherwise utilize processor-executable code stored in a non-transitory tangible processor readable medium. Numerous variations on the embodiments herein disclosed are also possible. For instance, the CPU frequency scaling governor 112 may be selected from the following non-exclusive CPU governor list: interactive, smoothass, conservative, ondemand, userspace, powersave, performance, smartass, and always max.

In general, the Dependent task identifier 118 and the CPU frequency scaling governor 112 operate to adjust the operating frequency of each of the processor cores 116 based upon the work that each processor core is performing. For instance, the governor 112 can periodically determine the aggregate dependent UI task frequency (as per Equation-II) and determine whether to raise or lower the app processor 114 operating frequency for the subsequent frame processing (0, 1, 2, as seen in FIG. 4). In one or more embodiments, processor frequency control may be carried out independently on each processor core, with each processor core scaling independently of the others (asynchronous). However, it is contemplated that synchronized frequency scaling may also occur (each processing unit 116 set to the same frequency). Most modern embedded system SoC's (e.g. Snapdragon 810) deploy synchronous frequency scaling on the processor cores.

Among other functions, the kernel scheduling component 118 may migrate tasks between the processor cores 116 to balance the load that is being processed by the app processor 114. Unlike prior kernel 108 implementations, the exemplary embodiment tracks the dependency of tasks that are dispersed among the cores 116, which enables the ability to track the composite load of multiple dependent tasks. The Dependent task identifier 118 may then provide combined load information 127 to the governor 112 so that the governor 112 may adjust the frequency of one or more of the cores so that the overall task may be timely processed to maintain or improve a user's experience. Therefore, the governor scales the frequency on a combined load across all the tasks (e.g. tasks A, B, and C seen in FIG. 4), creating a single unit of load/frequency for scaling.

In one embodiment, the UI tasks may be processed by three processing threads: the UI/Activity main thread, the Renderer thread, and the Binder transaction thread. And the Dependent task identifier 118 may track the dependency of these threads and the tasks therein to generate the combined load information 127 based upon the requirements of the overall UI task (Equation-II above). In this way, the combined load information 127 may be used by the governor 112 to adjust the frequency of one or more of the cores 116 so that the overall UI task is timely completed (e.g., to maintain 60 fps UI performance).

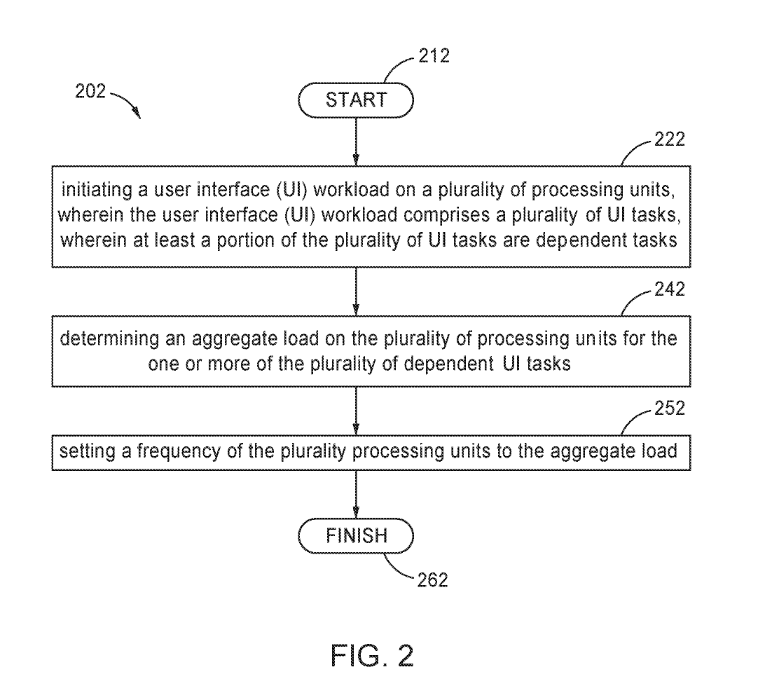

Turning now to FIG. 2, seen is a method 202 of adjusting a processing unit frequency, such as, but not limited to, the frequency of the processing unit 116 in FIG. 1. One method 202 starts at 212 and at 222 comprises initiating a user interface (UI) workload on a plurality of processing units 116 such as, but not limited, a workload associated with a user interface related to an application 102 (e.g., a scrolling UI animation workload in response to a scroll operation on top of a touchscreen enabled mobile display device for an application like Gmail, Facebook etc.). As previously described, the user interface workload comprises a plurality of UI tasks that may be relayed to the Dependent task identifier 118 through the system calls 107. The UI workload in step 222 comprises a plurality of UI tasks 104, with at least a portion of the UI tasks 104 comprising dependent tasks. At 242, the method 202 comprises determining an aggregate load on the plurality of processing units for the one or more of the plurality of UI tasks 104. The aggregate load is determined by determining the total load across all tasks included in the dependent chain as per Equation-II above. Upon obtaining the load, the method at 252 comprises setting a frequency of the plurality of processing units 116 to the aggregate load. The method 202 ends at 262.

Another method 202 may comprise executing each of the plurality of UI tasks on one of the plurality of processing units 116 and the desired aggregate frequency. Furthermore, the plurality of processing units may comprise a plurality of processing cores, as disclosed in relation to FIG. 1. It is further contemplated that executing each of the plurality of UI tasks on one of the plurality of processing units may comprises executing each of the plurality of UI tasks within a VSYNC boundary. One such boundary may comprise about 16.66 ms, as described elsewhere herein.

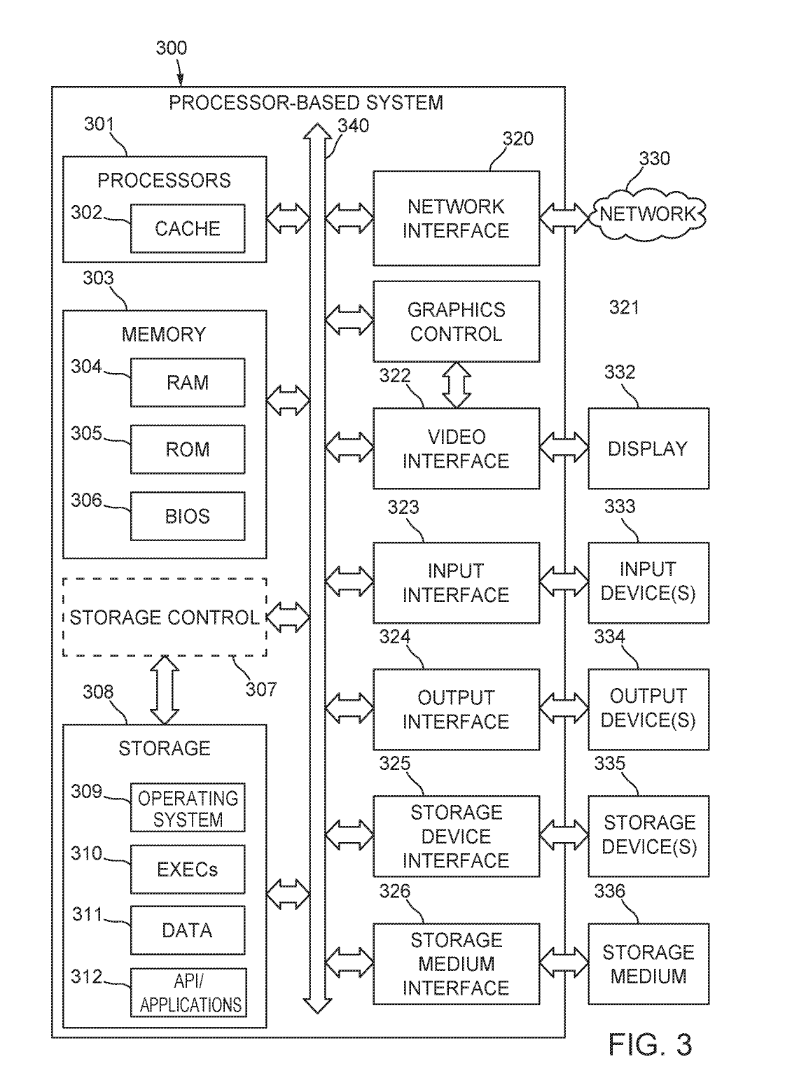

As described herein and in reference to FIGS. 1, 3 and elsewhere, one embodiment comprises a non-transitory, tangible computer readable storage medium, encoded with processor readable instructions to perform a method of adjusting a frequency of a processing unit 116. One such method may comprise the method 202 seen in FIG. 2. In addition to the steps seen in FIG. 2, such a method 202 may further comprise setting a frequency of the plurality of processing units 116 to the aggregate load, upon obtaining the desired aggregate to process all dependent-chain tasks.

The method may further comprise providing an inquiry from the cpu frequency scaling governor 112 to determine the workload required by the user interface in order to properly display and operate the application 102 at the display refresh rate. As described herein, the Dependent task identifier 118 may identify the one or more of the plurality of UI tasks that are dependent on at least one other of the plurality of UI tasks and determines the aggregate load on the plurality of processing units for the one or more of the plurality of UI tasks that are dependent on at least one other of the plurality of UI tasks. It is contemplated that the Dependent task identifier 118 may comprise a Linux kernel process scheduler.

The systems and methods described herein can be implemented in a machine such as a processor-based system in addition to the specific physical devices described herein. FIG. 3 shows a diagrammatic representation of one embodiment of a machine in the exemplary form of a processor-based system 300 within which a set of instructions can execute for causing a device to perform or execute any one or more of the aspects and/or methodologies of the present disclosure. The components in FIG. 2 are examples only and do not limit the scope of use or functionality of any hardware, software, embedded logic component, or a combination of two or more such components implementing particular embodiments.

Processor-based system 300 may include processors 301, a memory 303, and storage 308 that communicate with each other, and with other components, via a bus 340. The bus 340 may also link a display 332 (e.g., touch screen display), one or more input devices 333 (which may, for example, include a keypad, a keyboard, a mouse, a stylus, etc.), one or more output devices 334, one or more storage devices 335, and various tangible storage media 336. All of these elements may interface directly or via one or more interfaces or adaptors to the bus 340. For instance, the various non-transitory tangible storage media 336 can interface with the bus 340 via storage medium interface 326. Processor-based system 300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processors 301 (or central processing unit(s) (CPU(s))) optionally contain a cache memory unit 302 for temporary local storage of instructions, data, or computer addresses. Processor(s) 301 are configured to assist in execution of processor-executable instructions. Processor-based system 300 may provide functionality as a result of the processor(s) 301 executing software embodied in one or more tangible, non-transitory processor-readable storage media, such as memory 303, storage 308, storage devices 335, and/or storage medium 336. The processor-readable media may store software that implements particular embodiments, and processor(s) 301 may execute the software. For example, processor-executable code may be executed to realize components of the kernel 108, interfaces 106, and UI tasks 104. Memory 303 may read the software from one or more other processor-readable media (such as mass storage device(s) 335, 336) or from one or more other sources through a suitable interface, such as network interface 320. The software may cause processor(s) 301 to carry out one or more processes or one or more steps of one or more processes described or illustrated herein such as the frequency scaling of one or more of the cores 116 based upon the unified load tracking. Carrying out such processes or steps may include defining data structures stored in memory 303 and modifying the data structures as directed by the software.

The memory 303 may include various components (e.g., machine readable media) including, but not limited to, a random access memory component (e.g., RAM 304) (e.g., a static RAM “SRAM”, a dynamic RAM “DRAM, etc.), a read-only component (e.g., ROM 305), and any combinations thereof. ROM 305 may act to communicate data and instructions unidirectionally to processor(s) 301, and RAM 304 may act to communicate data and instructions bidirectionally with processor(s) 301. ROM 305 and RAM 304 may include any suitable tangible processor-readable media described below. In one example, a basic input/output system 306 (BIOS), including basic routines that help to transfer information between elements within processor-based system 300, such as during start-up, may be stored in the memory 303.

Fixed storage 308 is connected bidirectionally to processor(s) 301, optionally through storage control unit 307. Fixed storage 308 provides additional data storage capacity and may also include any suitable tangible processor-readable media described herein. Storage 308 may be used to store operating system 309, EXECs 310 (executables), data 311, APV applications 312 (application programs), and the like. Often, although not always, storage 308 is a secondary storage medium (such as a hard disk) that is slower than primary storage (e.g., memory 303). Storage 308 can also include an optical disk drive, a solid-state memory device (e.g., flash-based systems), or a combination of any of the above. Information in storage 308 may, in appropriate cases, be incorporated as virtual memory in memory 303.

In one example, storage device(s) 335 may be removably interfaced with processor-based system 300 (e.g., via an external port connector (not shown)) via a storage device interface 325. Particularly, storage device(s) 335 and an associated machine-readable medium may provide nonvolatile and/or volatile storage of machine-readable instructions, data structures, program modules, and/or other data for the processor-based system 300. In one example, software may reside, completely or partially, within a machine-readable medium on storage device(s) 335. In another example, software may reside, completely or partially, within processor(s) 301.

Bus 340 connects a wide variety of subsystems. Herein, reference to a bus may encompass one or more digital signal lines serving a common function, where appropriate. Bus 340 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Processor-based system 300 may also include an input device 333. In one example, a user of processor-based system 300 may enter commands and/or other information into processor-based system 300 via input device(s) 333. Examples of an input device(s) 333 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 333 may be interfaced to bus 340 via any of a variety of input interfaces 323 (e.g., input interface 323) including, but not limited to, serial, parallel, game port, USB, FIREWIRE, THUNDERBOLT, or any combination of the above.

In particular embodiments, when processor-based system 300 is connected to network 330, processor-based system 300 may communicate with other devices, specifically mobile devices and enterprise systems, connected to network 330. Communications to and from processor-based system 300 may be sent through network interface 320. For example, network interface 320 may receive incoming communications (such as requests or responses from other devices) in the form of one or more packets (such as Internet Protocol (IP) packets) from network 330, and processor-based system 300 may store the incoming communications in memory 303 for processing. Processor-based system 300 may similarly store outgoing communications (such as requests or responses to other devices) in the form of one or more packets in memory 303 and communicated to network 630 from network interface 320. Processor(s) 301 may access these communication packets stored in memory 303 for processing.

Examples of the network interface 320 include, but are not limited to, a network interface card, a modem, and any combination thereof. Examples of a network 330 or network segment 330 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, may employ a wired and/or a wireless mode of communication. In general, any network topology may be used.

Information and data can be displayed through a display 332. Examples of a display 332 include, but are not limited to, a liquid crystal display (LCD), an organic liquid crystal display (OLED), a cathode ray tube (CRT), a plasma display, and any combinations thereof. The display 332 can interface to the processor(s) 301, memory 303, and fixed storage 308, as well as other devices, such as input device(s) 333, via the bus 340. The display 332 is linked to the bus 340 via a video interface 322, and transport of data between the display 332 and the bus 340 can be controlled via the graphics control 321.

In addition to a display 332, processor-based system 300 may include one or more other peripheral output devices 334 including, but not limited to, an audio speaker, a printer, and any combinations thereof. Such peripheral output devices may be connected to the bus 340 via an output interface 324. Examples of an output interface 324 include, but are not limited to, a serial port, a parallel connection, a USB port, a FIREWIRE port, a THUNDERBOLT port, and any combinations thereof.

In addition or as an alternative, processor-based system 300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a processor-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, or hardware in connection with software. Various illustrative components, blocks, modules, circuits, and steps have been described above generally in terms of their functionality. Whether such functionality is implemented as hardware or hardware that utilizes software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
a plurality of processing units operating at a processing unit frequency;
a dependent task identifier; and
a CPU frequency scaling governor,
wherein
the dependent task identifier identifies one or more user interface tasks of a plurality of user interface tasks and provides an aggregate frequency for the one or more user interface tasks to the CPU frequency scaling governor,
the one or more user interface tasks dependent on at least one other user interface task of the plurality of user interface tasks, and
the CPU frequency scaling governor sets the plurality of processing units to the aggregate frequency based on an aggregate load.

2. The computing device of claim 1, wherein the CPU frequency scaling governor sets the plurality of processing units to the aggregate frequency for a predetermined period of time.

3. The computing device of claim 2, wherein the predetermined period of time comprises substantially 20 milliseconds.

4. The computing device of claim 1, wherein the CPU frequency scaling governor further requests the aggregate load from the dependent task identifier prior to the dependent task identifier providing the aggregate frequency.

5. The computing device of claim 1, wherein one or more user interface tasks dependent on at least one other user interface task comprises a first task that signals at least one additional task.

6. The computing device of claim 1, wherein the aggregate frequency comprises a single frequency across the plurality of processing units.

7. The computing device of claim 1, wherein the dependent task identifier and CPU frequency scaling governor comprise a portion of an operating system kernel.

8. A method of adjusting a processing unit frequency comprising:
initiating a user interface workload on a plurality of processing units, wherein the user interface workload comprises a plurality of user interface tasks;
identifying one or more of the plurality of user interface tasks that are dependent on at least one other of the plurality of user interface tasks;
determining an aggregate load on the plurality of processing units for the one or more of the plurality of user interface tasks that are dependent on at least one other of the plurality of user interface tasks; and
setting a frequency of the plurality of processing units to the aggregate load.

9. The method of claim 8, wherein the aggregate load comprises the processing frequency to complete the one or more of the plurality of user interface tasks that are dependent on the at least one other of the plurality of user interface tasks.

10. The method of claim 8, wherein identifying one or more of the plurality of user interface tasks that are dependent on at least one other of the plurality of user interface tasks comprises identifying one or more of the plurality of user interface tasks that are dependent on at least one other of the plurality of user interface tasks for a given period of time.

11. The method of claim 8, wherein the given period of time comprises 20 milliseconds or less.

12. The method of claim 8 further comprising executing each of the plurality of user interface tasks on one of the plurality of processing units.

13. The method of claim 12, wherein the plurality of processing units comprises a plurality of processing cores.

14. The method of claim 12, wherein executing each of the plurality of user interface tasks on one of the plurality of processing units comprises executing each of the plurality of user interface tasks within a VSYNC boundary.

15. The method of claim 14, wherein the VSYNC boundary comprises about 16.66 ms.

16. A non-transitory, tangible computer readable storage medium, encoded with processor readable instructions to perform a method of adjusting a processing unit frequency, the method comprising:
initiating a user interface workload on a plurality of processing units, wherein the user interface workload comprises a plurality of user interface tasks;
identifying one or more of the plurality of user interface tasks that are dependent on at least one other of the plurality of user interface tasks;
determining an aggregate load on the plurality of processing units for the one or more of the plurality of user interface tasks that are dependent on at least one other of the plurality of user interface tasks; and
setting a frequency of the plurality of processing units to the aggregate load.

17. The non-transitory, tangible computer readable storage medium of claim 16, further comprising, providing an inquiry from a CPU frequency scaling governor to determine the user interface workload from a dependent task identifier.

18. The non-transitory, tangible computer readable storage medium of claim 17, wherein the dependent task identifier:
identifies the one or more of the plurality of user interface tasks that are dependent on at least one other of the plurality of user interface tasks, and
determines the aggregate load on the plurality of processing units for the one or more of the plurality of user interface tasks that are dependent on at least one other of the plurality of user interface tasks.

19. The non-transitory, tangible computer readable storage medium of claim 18, wherein the dependent task identifier comprises a Linux kernel process scheduler.
